(19) United States
(12) Patent Application Publication
(10) Pub. No.: US 2005/0220699 A1
(43) Pub. Date: Oct. 6, 2005

(54) Method for preparing Chevrel phase materials

(76) Inventors: Yosef Gofer, Hod Hasharon (IL); Eli Lancry, Ashdod (IL); Haim Gizbar, Holon (IL); Orlt Chasid, Zur-Igral (IL); Sergiy Malovanyy, Kyiv (UA); Doron Aurbach, Bney Brack (IL); Elena Levi, Ganey-Aviv Lod (IL)

Correspondence Address: GOTTLIEB RACKMAN & REISMAN PC, 270 MADISON AVENUE, 8TH FLOOR, NEW YORK, NY, 100160601, US

(21) Appl. No.: 11/096,110

(22) Filed: Mar. 31, 2005

Related U.S. Application Data
(60) Provisional application No. 60/558,626, filed on Apr. 1, 2004.

(51) Int. Cl. C01F 1/00

(52) U.S. Cl. 423/561.1

(57) ABSTRACT

Chevrel phase materials are made by heating the source materials in an open furnace. In addition to the chalcogen and the molybdenum, a low melting point salt is introduced to the preparation mixture.

### FIELD OF THE INVENTION

The present invention is in the field of production of Chevrel phase materials. The product of the method of the invention may be used in the manufacturing of superconductors, catalysts and cathodes for electrochemical cells. 10

### BRIEF DESCRIPTION OF THE DRAWINGS

FIG. 1 is a generalized sequence step chart of the method for the production of Chevrel phase materials

FIG. 2 is a schematic sequence chart of a prior art laboratory method for the production of Chevrel phase materials

FIG. 3 is an X ray diffraction graph describing the characteristics of Chevrel phase materials produced in accordance with the invention.

### BACKGROUND OF THE INVENTION

Chevrel compounds, also known as Chevrel phase compounds or materials, typically consist of molybdenum and a chalcogen such as sulfur, in a specific stoichiometric ratio. Chevrel phase materials are proposed as starting material for the production of superconductive components, catalysts for the petroleum industry and cathodes for batteries.

Chevrel compounds may contain other metals in addition to molybdenum. The incorporation of the additional metals into the Chevrel compound can be performed either in a chemical or electrochemical reaction. Energy is released upon the inclusion of such additional metals in the Chevrel crystal, and the inclusion is reversible at least to some extent. This property provide the grounds for the use of Chevrel materials as cathodes in electrochemical cells.

### SUMMARY OF THE INVENTION

A method for the preparation of Chevrel compounds according to the present invention uses a low melting salt as a flux. In prior art methods, Chevrel materials are prepared by mixing of chalcogens, molybdenum and an additional leachable metal, such as copper. The ingredients are mixed and heated under a vacuum. Later, the vacuum is stopped and the leachable metal is leached. In the method of the invention, a flux in the form of low salt is added, obviating the vacuum and decreasing the temperature of production.

### DESCRIPTION OF THE PRESENT INVENTION

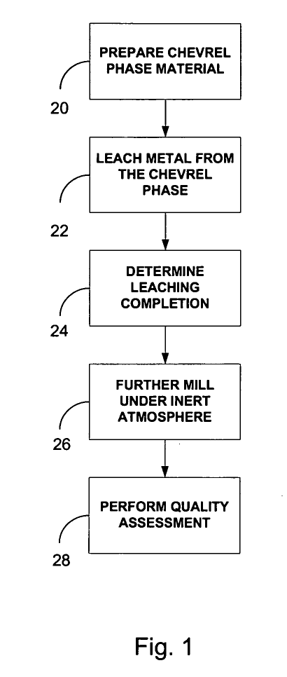

The present invention provides a method for the production of Chevrel phase materials consisting of molybdenum reacted with a chalcogen, and in some cases, also with an additional metal, called ternary metal. The overall process in which the invention is incorporated is described schematically with reference to FIG. 1. In step 20 Chevrel phase material is prepared with additional metal. In step 22 the additional metal is leached, and in step 24 the completion of leaching is determined. In step 26 the resultant Chevrel material is preferably milled under inert atmosphere to produce finer particles, and in step 28 a quality assessment is performed.

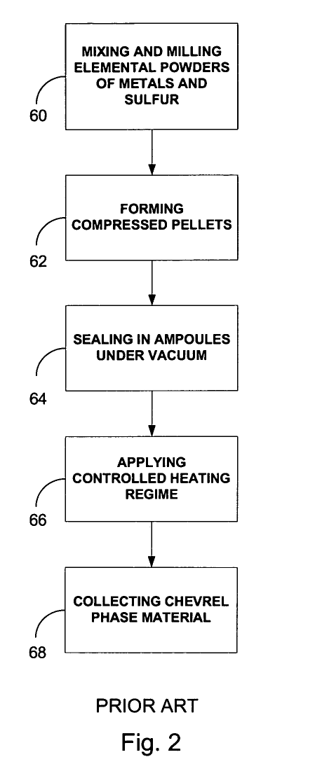

In the laboratory, on a small scale of a few grams to a few tens of grams a Chevrel phase material (CPM), is produced as in the prior art, as will be described next with reference to FIG. 2. In step 60 the elemental metals, copper powder (99.7%, >3 μm), molybdenum powder (99.95%, >10 μm), and sulfur powder (99.98%), are mixed in the ratio of 2:6:8, respectively. The powders are mixed and preferably milled, conveniently by using mortar and pestle manually. In step 62 the milled powder is pressed into pellets under pressure of about 3000 psi. A pellet is placed in an ampoule and sealed under vacuum at step 64. A suitable vacuum is about 10⁻⁵ atm. At step 66, a thermal regime is applied to the ampoules as described next.
a. Heating to 400° C. at a rate of 400° C./hr.
b. Constant temperature of 450° C. for 24 hours.
c. Raising the temperature from 450° C. to 700° C. at a rate of 120° C./hr.
d. Holding a constant temperature of 700° C. for 24 hours.
e. Raising the temperature from 700° C. to 1050° C. at a rate of 120° C./hr.
f. Holding a constant temperature of 1050° C. for 48 hr.
g. Cooling from 1050° C. to room temperature at a rate of 120° C./hr.
   (hr stands for hours, and g for grams throughout the description).

The product of the reaction is Cu₂Mo₆S₈ (Chevrel phase material). At step 68 the material is completed and can be collected for further processing, for example, for the production of cathodes for electrochemical cells.

Industrially, the procedure preferably employs different starting materials. Such a process utilizes mainly salts and compounds of molybdenum, the chalcogenide and the ternary metal, in case it is incorporated. As an example, 0.4 g of CuS, 1.0 g of MoS₂, 0.6 g of Mo and 2 g of KCl (as a flux) are mixed. The ratios given reflect the calculation relating to the equation as follows:
2CuS+3MoS₂+3Mo Cu₂Mo₆S₈.

The KCl is used conveniently but can be replaced by any low melting point1salt used as a flux but not reactive otherwise. The obtained mixture is placed in alumina crucible in an open vertical furnace under inert gas flow. The reaction mixture is heated to the 850° C. for 60 hours, after which it is cooled to room temperature. Then, the reaction products are washed by water for removing the salt flux. The obtained powder is filtered and washed four times with distilled water. After washing sample is dried at 110° C. and prepared for XRD (X-ray diffraction) analysis. The procedure can be modified as to include other metals instead of copper solely or in combination, typically in the form of sulfides. For example ZnS, NiS, Ag, Pg, Mg and Li. Generally, the stoichiometric formula of the generalized Chevrel phase material is as follows:
MₓMo₆S₈

Where: M stands for metal, x stand for 1 to 4.

Sulfur can be replaced partially or completely by selenium. Suitable sources for selenium in this case are metal selenides such as MoSe2, CuSe, CuSe2, NiSe, ZnSe. The product produced using such starting materials has a formula as follows:
MₓMo₆S₆—_{y}Se_{y}

Where x=1 to 4, M standing for any metal, and y=0 to 6.

Then, the additional metal, when present, is leached out of the Cu₂Mo₆S₈ (Chevrel phase). The purpose of the leaching is to obtain an empty structure of Mo₆S₈, For example when the product is used for the manufacturing of cathodes. Two leaching regimes can be employed. An aqueous phase leaching is performed as follows: 15
1. 2 grams of Cu₂Mo₆S₈ are stirred in 20 ml of 1:1 HCl:water, in an open to air beaker for 2-4 days, at room temperature. To expedite the action, oxygen is bubbled (100 cc/min) for 7 hours at room temperature.
2. Slurry Filtered.
3. Pellet washed twice with 100 ml clean water.
4. Powder dried for 0.5 hour at 120° C.
5. XRD analysis is performed to confirm the completion of the leaching (obtaining Mo₆S₈ pure phase).

A non-aqueous phase leaching is performed as follows:
1. Cu₂Mo₆S₈ powder is mixed with 0.4M solution of dry acetonitrile/l₂. The normal ratio between the powder weight (grams) and the solution volume (ml) is 1:10.
2. Mixture is stirred for 5 days at room temperature.
3. Slurry is filtered discarding the fluid.
4. XRD analysis is performed to confirm completion of the leaching.

In order to improve the kinetic properties of the leached CPM it is desirable to decrease the particle size of the product. An optional milling process for such is described next. The milling should be performed under inert atmosphere such as pure argon using, for example, a Crescent-Wig L-Bug Amalgamator (Model 3110B).
1. Placing Mo₆S₈ powder (500 mg) and a steel ball in a cylindrical stainless steel vial (2 cm³). The weight ratio between the steel ball and the Chevrel powder being 2:1.
2. Milling for 5 min.
3. Performing XRD analysis in order to verify that no changes from the Mo₆S₈ pattern beside slight peaks intensity decrease took 20 place. Otherwise, the crystal structure is damaged.

Quality assessment of the composition of the invention employs two procedures performed serially.

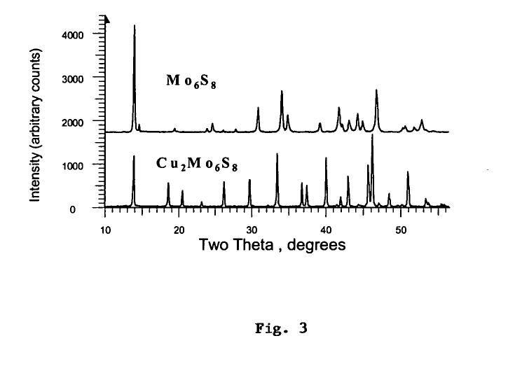

In one procedure, XRD measurements are performed in order to verify that the diffraction pattern obtained from this material is indeed of pure Mo₆S₈ (Chevrel phase material). The XRD patterns of Cu₂Mo₆S₈ and Mo₆S₈ are described in FIG. 3 to which reference is now made.

In the other procedure, electrochemical measurements are used to determine the quality of the product. Electrodes are prepared by applying 5-15 mg/cm² on stainless steel mesh (200 mesh) from slurry of 80% cathode material, 10% carbon black and 10% PVdF (Aldrich). This slurry is prepared with addition of N-methyl-pyrolidon (NMP). The traces of NMP are removed from the electrodes by drying at 800 C for 20-30 minutes. The conditions for the electrochemical measurements are: galvanostatic cycling (5-10 cycles) at current density of 0.1 mA/cm². On the first discharge a theoretical specific capacity of 120-130 mAh/gr is expected. From the second discharge, the expected specific capacity is not less than 85 mAh/gr and the reversibility should be close to 100%.

1. A method for producing Chevrel phase materials comprising the steps of:
mixing sources of at least one metal other than molybdenum, a source of molybdenum, a source of at least one material selected from the group including sulphur and selenium;
mixing said sources;
heating said mixture to a temperature required to produce Chevrel phase material, and
leaching said at least one metal other than molybdenum.

2. A method for producing Chevrel phase materials as in claim 1 and wherein said heating is performed in an open furnace in a crucible under flow of inert gas, and wherein a low melting point salt, or a mixture of salts, are introduced into said crucible as flux.

3. A method for producing Chevrel phase materials as in claim 2 and wherein the resultant Chevrel phase material is used for the production of cathodes for electrochemical cells.

4. A method for producing Chevrel phase materials as in claim 2 and wherein said low melting point salt is KCl.

5. A method for producing Chevrel phase materials as in claim 1 and wherein said sources are milled while being mixed.

6. A method for producing Chevrel phase materials as in claim 1 and wherein said temperature required to produce the Chevrel phase materials is not higher than 850° C.
